(19) United States
(12) Patent Application Publication
(10) Pub. No.: US 2006/0161725 A1
(43) Pub. Date: Jul. 20, 2006

(54) Multiple function flash memory system

(76) Inventors: Charles C. Lee, Sunnyvale, CA (US); I-kang Yu, Palo Alto, CA (US)

Correspondence Address: SAWYER LAW GROUP LLP, P O BOX 51418, PALO ALTO, CA, 94303, US

(21) Appl. No.: 11/040,326

(22) Filed: Jan. 20, 2005

(51) Int. Cl. G06F 12/00

(52) U.S. Cl. 711/103

(57) ABSTRACT

A system and method for implementing a flash memory system. The flash memory system includes a processor and at least one flash memory device. The at least one flash memory device includes a plurality of partitions. As a result, the flash memory system can utilize the multiple partitions to provide multiple functions such as an AutoRun feature.

### FIELD OF THE INVENTION

The present invention relates to memory systems, and more particularly to a multiple function flash memory system.

### BACKGROUND OF THE INVENTION

Flash memory devices are well known, and are becoming increasingly more popular. Benefits of flash memory devices include low-power consumption, high resistance to vibration, and high resistance to physical impact when accidentally dropped. These are primary reasons why flash memory devices have been replacing magnetic materials such as floppy disks.

USB flash memory devices are popular devices used for data storage. While conventional USB flash memory devices are limited to data storage, they are popular because they are portable, easily erasable, and easily formatted. A potential problem with conventional USB flash memory devices is that because they are easily erasable and easily formatted, they can be accidentally erased or reformatted. Accordingly, USB flash memory devices are typically used for transporting data, and not as permanent storage. Data stored on USB flash memory devices is typically backed up elsewhere, such as on a hard drive.

Accordingly, what is needed is an improved flash memory system. The system should be flexible, secure, simple, cost effective, and capable of being easily adapted to existing technology. The present invention addresses such a need.

### SUMMARY OF THE INVENTION

A system and method for implementing a flash memory system is disclosed. The flash memory system includes a processor and at least one flash memory device. The at least one flash memory device includes a plurality of partitions. As a result, the flash memory system can utilize the multiple partitions to provide multiple functions.

### BRIEF DESCRIPTION OF THE DRAWINGS

FIG. 1 is a block diagram of a conventional flash card coupled with a user host.

FIG. 2 is a block diagram of a flash memory system in accordance with the present invention.

FIG. 3 is a flow chart showing a method for implementing the flash memory system of FIG. 2 in accordance with the present invention.

FIG. 4 is a detailed block diagram of a flash memory system, which can be used to implement the flash memory system of FIG. 2, in accordance with the present invention.

FIG. 5 is a translation table, which can be used to implement the index of FIG. 2 or the address translation table of FIG. 4, in accordance with the present invention.

FIGS. 6A and 6B are exemplary applications of the address translation table of FIG. 5 in accordance with the present invention.

FIG. 7 is a flow chart showing a method for providing the translation table of FIG. 5 in accordance with the present invention.

FIG. 8 is a translation table in accordance with another embodiment of the present invention.

FIG. 9 is a flow chart showing a method for constructing the translation table of FIG. 8 in accordance with the present invention.

FIG. 10 is a flow chart showing a method for programming a flash memory system of FIG. 4 in accordance with the present invention.

FIG. 11 is a flow chart showing a method for setting-up an AutoRun function with a manufacturing host in accordance with the present invention.

FIG. 12 is a flow chart showing a method for running an AutoRun function user mode in accordance with the present invention.

FIG. 13 is a flow chart showing a method for booting up a read-only memory (ROM), in accordance with the present invention.

FIG. 14 is a flow chart showing a method for setting up a security partition of the manufacturing test in accordance with the present invention.

FIG. 15 is a flow chart showing a method for operating a security partition in user mode in accordance with the present invention.

### DETAILED DESCRIPTION OF THE INVENTION

The present invention relates to memory systems, and more particularly to a multiple function flash memory system. The following description is presented to enable one of ordinary skill in the art to make and use the invention, and is provided in the context of a patent application and its requirements. Various modifications to the preferred embodiment and the generic principles and features described herein will be readily apparent to those skilled in the art. Thus, the present invention is not intended to be limited to the embodiment shown, but is to be accorded the widest scope consistent with the principles and features described herein.

A system in accordance with the present invention for implementing a flash memory system is disclosed. The flash memory system includes a flash memory having multiple partitions. The flash memory system can utilize the multiple partitions to provide multiple functions. The functions can include, for example, an AutoRun function, non-secured data storage, and secured data storage. To more particularly describe the features of the present invention, refer now to the following description in conjunction with the accompanying figures.

Although the present invention disclosed herein is described in the context of a flash card compatible with the USB standard, the present invention may apply to other types of memory systems compatible with other types of standards and still remain within the spirit and scope of the present invention.

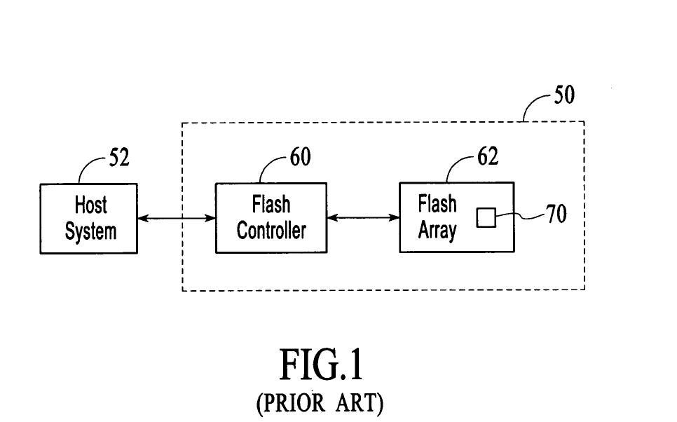

FIG. 1 is a block diagram of a conventional flash card 50 coupled with a user host 52. The flash card 50 includes a flash controller 60 and a flash memory device 62. The user host 52 can be a camera or a PC, for example. Data is transferred between the user host 52 and the flash memory device 62 via the flash controller 60. When the flash card 50 is plugged into the user host 52, the flash card 50 provides to the user host 52 storage space 70 from the flash memory device 62. In addition to the flash card 50, the user host 52 may also be connected to other hardware components (not shown) such as hard drives, floppy drives, compact disc (CD) drives, etc.

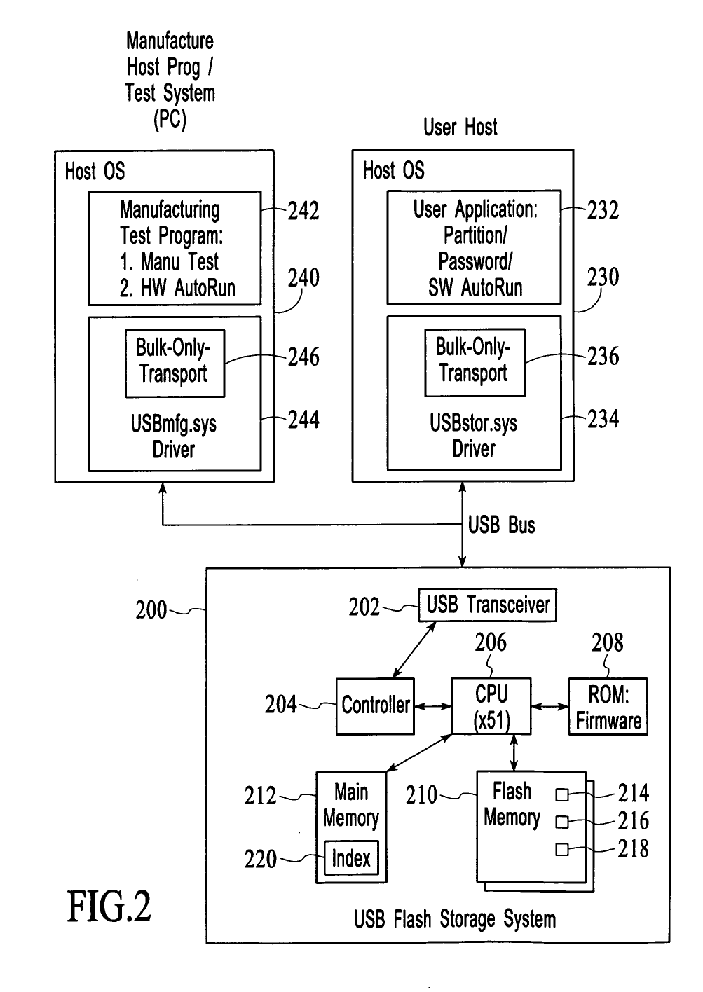

FIG. 2 is a block diagram of a flash memory system 200 in accordance with the present invention. The flash memory system 200 includes a transceiver 202, a flash controller 204, a central processing unit (CPU) 206, a read-only memory (ROM) 208, a flash memory 210, and a main memory 212. In this specific embodiment, the transceiver 202 is a USB transceiver. Note that the term flash memory represents one or more flash memory devices. The flash memory controller is an embedded controller and handles most of the CPU commands that are provided by the firmware in the ROM 208.

In accordance with the present invention, the flash memory 210 has multiple partitions 214, 216, 218. The specific number of partitions will vary and will depend on the specific application. The flash memory system 200 utilizes the multiple partitions 214-218 to provide multiple functions. Access to the multiple partitions is provided by an index 220 in the main memory 212. The functions can include, for example, an AutoRun function, non-secured data storage, and secured data storage. Embodiments implementing the multiple partitions 214-218, the index 220, and these exemplary functions are described in detail below in the remaining figures.

During normal-mode operation, the flash memory system 200 is adapted to be coupled to a user host 230. The user host 230 can be a PC or Mac-based personal computer. The user host 230 includes a user application 232 and a driver 234 which executes a bulk-only-transport (BOT) protocol 236. In this specific embodiment, the driver 236 is a USB driver, and can be provided by an operating system such as Windows.

During programming-mode operation, the flash memory system 200 is adapted to be coupled to a manufacturer host 240. The manufacturer host 240 can be a personal computer (PC) having special programming hardware and software. In this specific embodiment, the manufacturer host 240 includes a manufacturing application 242 and a driver 244 which executes a BOT protocol 246. In this specific embodiment, the driver 246 is a USB driver.

The manufacturer host 240 programs the flash memory system 200 before it is shipped to an end user. This programming enables the flash memory system 200 to create the multiple partitions 214, 216, and 218 and to execute multiple functions such as data storage and the AutoRun function. The driver 246 is a special driver (USBmfg.sys for example) which facilitates in the programming. The BOT protocol 246 commands facilitate in programming reserved areas of the flash memory 210.

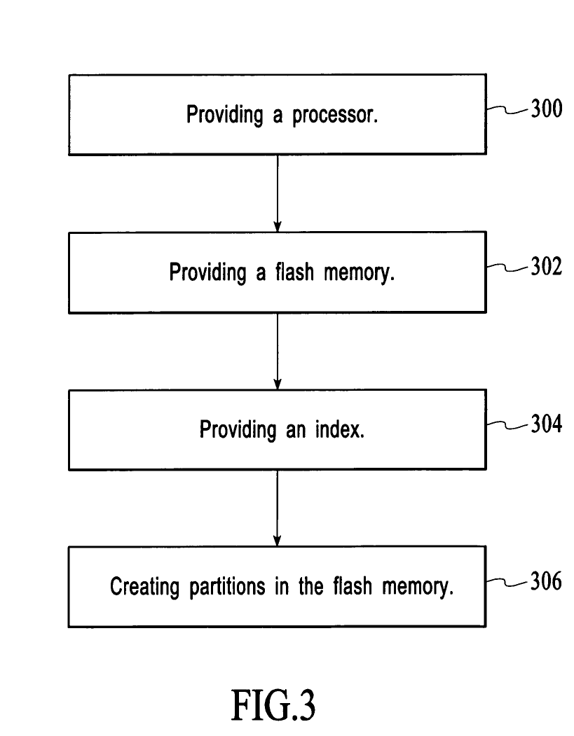

FIG. 3 is a flow chart showing a method for implementing the flash memory system 200 of FIG. 2 in accordance with the present invention. Referring to both FIGS. 2 and 3 together, the processor 206 is provided, in a step 300. Next, the flash memory 210 is provided, in a step 302. Next, the index 220 is provided, in a step 304. The index 220 stores information regarding the configuration of the flash memory 210 such as how many partitions it has and how the partitions are formatted (e.g. CD ROM, disk drive, etc.). Next, the partitions 214-218 are created in the flash memory 210, in a step 306. The processor 206 utilizes the index 220 to create the partitions 214-218 in the flash memory 210.

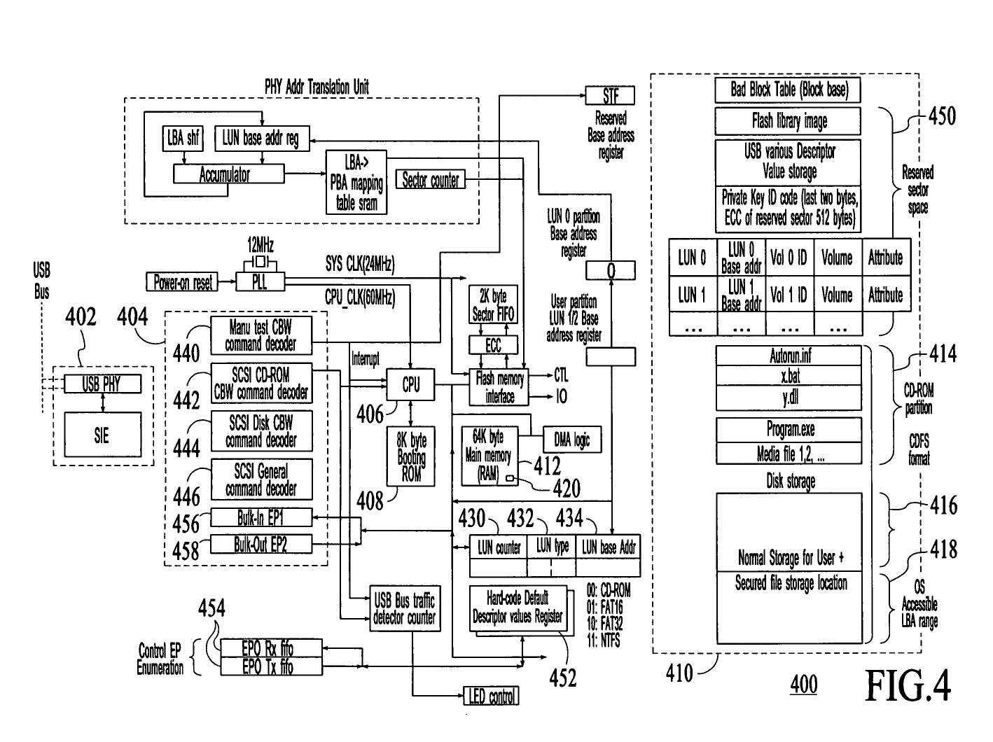

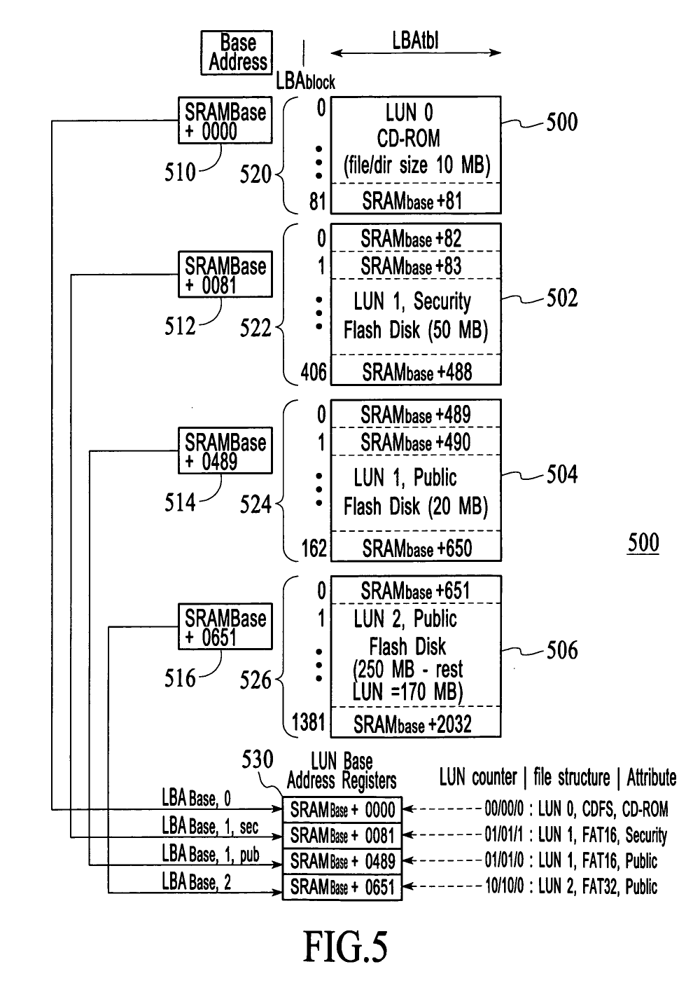

FIG. 4 is a detailed block diagram of a flash memory system 400, which can be used to implement the flash memory system 200 of FIG. 2, in accordance with the present invention. Generally, the flash memory system 400 includes a transceiver 402, a flash controller 404, a CPU 406, a ROM 408, a flash memory 410, and a main memory 412. The flash memory 410 has multiple partitions 414, 416, and 418. The main memory 412 stores an index or address translation table 420. The address translation table 420 stores information regarding the configuration of the flash memory 410 such as how many partitions it has and how the partitions are formatted (e.g. as a CD ROM, disk drive, etc.). The address translation table 420 also enables the CPU 406 to access the multiple partitions 414-418.

Multiple Partitions

In accordance with the present invention, the partitions 414-418 can have different file structures. Examples of such file structures are CD file structures (CDFSs), file allocation tables (FATs) such as FAT16 and FAT 32, and NT file structures (NTFSs). By having the multiple partitions 414-418 with different file structures, the flash memory system 400 can have multiple functions. For example, one partition 414 (which may also be referred to as partition 0) can be formatted as a compact disk (CD) read-only memory (ROM) type partition, which uses a CDFS file structure. The CD ROM format enables the flash memory system to support an AutoRun function. The AutoRun function is described in more detail further below.

Another partition 416 (may also be referred to as partition 1) can be formatted as a disk partition. A disk partition can use different file structures (such as FAT16, FAT 32, or NTFS, etc.) and can be used for typical flash memory usage (i.e. data storage). Being a disk type partition, this partition can be configured as a public partition, where it can be accessed without conditions (e.g. without a required password).

Another partition 418 (e.g. may also be referred to as partition 2) can also be formatted as a disk partition. In accordance with the present invention, a disk partition can be configured as a public partition or as a secured partition. If the disk partition is a secured partition, it can be accessed with a special utility program through a password. The secured partition is described in more detail further below. The types of partitions that can be used and the specific number of partitions will depend on the manufacturing specific application.

The flash memory system 400 also includes a logic unit number (LUN) counter 430, a LUN type register 432, and a LUN base address register 434. The flash controller 404 includes a manufacturer special command decoder 440, a small computer systems interface (SCSI) CD ROM dedicated command decoder 442, a SCSI fixed-disk type command decoder 444, and a SCSI general command decoder 446.

Multiple Logic Unit Numbers (LUNS)

The address translation table 420 includes information regarding the configuration of the flash memory 410, and the CPU 406 can utilize the address translation table 420 to create and access the multiple partitions 414-418 in the flash memory 410. More specifically, in accordance with the present invention, the address translation table 420 associates LUNs with the respective partitions 414-418. A LUN is a unique identifier used on a SCSI bus to distinguish between devices that share the same bus.

In operation, the LUNs are used to identify each partition, and one LUN can correspond to one or more partitions. For example, one LUN can correspond to a CD ROM partition, which can be utilized for the AutoRun function. Another LUN can correspond to two disk-type partitions, which can be utilized for public and secured partitions. The number LUNs and the types of partitions associated with each LUNs will vary and will depend on the specific implementation.

The LUN counter 430 resets and increments partition numbers. Each partition has a different type of removable or fixed storage function, volume capacity, and volume ID or drive letter. The LUN base address register 434 stores an address for each partition and a high order most significant bit (MSB) 3-bit value of total capacity. The LUN base address register 434 is a non-volatile register. Each particular partition corresponds to a LUN number, which can be determined by the manufacturing program.

A reserved area 450 stores 512 bytes of pre-programmed control information for the flash memory 410. The control information includes LUN numbers, LUN types, volume capacity, IDs, holding capacities of non-volatile registers, partition information, etc. In a specific embodiment, the holding capacities of non-volatile registers and each partition information are stored in the first available address space of the reserved area 450. Typically, the information in the reserved area 450 needs to be programmed at a manufacturing site for initial setup or later re-programmed for recall purposes or for firmware updates. In a specific embodiment, up to four copies (for purposes such as copying, backup, etc.) of the control information in the reserved area are preserved to facilitate erase-before-write operations of the flash memory. A “reserved space ratio,” which is the amount of reserved flash memory space relative to the capacity of the flash memory, is determined by the manufacturer.

A CD ROM-base zone follows the reserved area 450 in the flash memory. The memory space dedicated to different function blocks can be referred to as zones. The reserved area can have one zone number (e.g. 000) and the CD ROM related address can have another zone number (e.g. 001, if the reserve space occupies only one zone). As disk storage zone requires frequent reads and writes, certain zone numbers associated with the final physical address spaces initially can be dedicated for wear leveling. However, wear leveling blocks can be later relocated anywhere except the reserved zones and CD-ROM zone.

The main memory 412 is random access memory (RAM) and stores the address translation table 420, which keeps track of valid copies of data, by mapping LUNs together with logical block addresses (LBAs), which are mapped to physical address blocks (PBAs).

Hard-coded registers 452 are used to respond back to the user host, especially when the flash memory is non-programmed (totally empty), so that a default value in the enumeration descriptor is sent back to the user host. If the flash memory system 400 is already programmed, a programmed value in the enumeration descriptor is sent back instead of a default value.

The architecture of the flash memory system 400 utilizes bulk-only-transport protocols and a command block wrapper (CBW) having 31 bytes of control information. A manufacturing command (e.g. F1, F2, etc., those specially coded command not listed in SCSI command manual) or a general purpose command block wrapper command block (CBWCB) (such as an SCSI inquiry command), and a dedicated Request-LUN-Number command (e.g. 43h command code) are decoded and passed to the flash controller 404 for proper operation of the flash memory system 400.

An endpoint 0 (EP0) 454 is dedicated to the enumeration process, and a packet size (e.g. 64 bytes) is programmed in a device descriptor field for information transfers.

The endpoint 1 (EP1) 456 is a bulk-in pipe for a host to read data from the flash memory system. The endpoint 2 (EP2) 458 is a bulk-out pipe for a host to send data to the flash memory system. The sizes (e.g. 64 bytes for USB version 1.1, and 512 bytes for USB version 2.0) of the EP1 456 and the EP2 458 can vary and will depend on the specific application.

FIG. 5 is an example of translation table 500 of four partitions, which can be used to implement the index 220 of FIG. 2 or the address translation table 420 of FIG. 4, in accordance with the present invention. The translation table includes LUNs 500, 502, 504, and 506. The LUNs 500, 502, 504, and 506 are also referred to as LUN 0, LUN 1, LUN 2, LUN 3, respectively. In a specific embodiment, the CD ROM partition is assigned to the LUN0 500. The LUN0 500 is given the highest priority by the Windows operating system (OS) and will show a lower drive letter. The LUNs 502 to 506 are each assigned to separate partitions. The partition associated with the LUN 502 is password protected, and the partition associated with the LUN 504 and 506 are public, i.e. available for general access. In this example two public partitions are useful for data organizations.

In operation, the address translation table 420 maps the LUNs 500-506 and the LBAs from the host to the PBAs. The LUNs 500, 502, 504, and 506 are associated with respective SRAM base addresses 510, 512, 514, and 516, respectively, and associated with respective LBA_{blk} 520, 522, 524, and 526, respectively. Generally, the LUNs 500-506 and LBA_{blk} 520-526 are used by flash device firmware to calculate PBAs. The LBA_{blk} 520-526 are added to the respective base address value stored in LUN base address registers 530. Adding an LBA_{blk} 520-526 to a base address 510-516 provides a unique value for address translation. The unique value is a PBA, which reflects a flash memory physical address for controller access. A method for calculating the LBA_{blk} is discussed below in the following section.

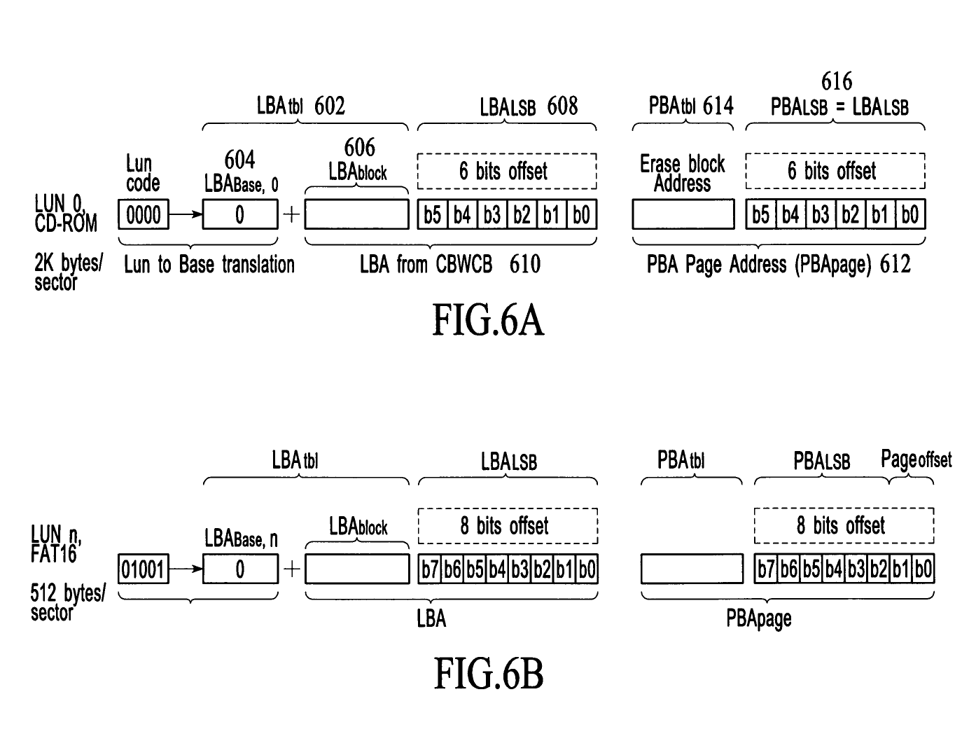

FIGS. 6A and 6B are exemplary applications of the address translation table 500 of FIG. 5 in accordance with the present invention. The flash memory in this example is 256 Mega bits total capacity, which is organized as 2K bytes per page, and 64 pages per erasable block. FIG. 6A is applied to a partition that is formatted as a CD ROM partition (i.e. 2K bytes per CD-ROM sector), and FIG. 6B is applied to a partition that is formatted as a disk partition (i.e. 512 bytes per disk sector). Generally, the LUNs and LBAs are used by flash device firmware to calculate PBAs for physical block address access.

Referring to FIG. 6A, the value in the LBA column 602 (LBA_{tbl}) is formed by summing an LBA base address 604 and an LBA_{blk} address 606. The LBA base address 604 is the same as the LUN base address. The LBA_{blk} address 606 is a value derived from an LBA provided by the CBWCB 610 by LBA_{LSB} 608 (i.e. right shifting a particular number of bits). In this example, it is shifted by 6 bits in the case of an erasable block having 64 pages. A PBA page address 612, which has 2K bytes per page, is formed by two components, a PBA_{tbl} 614 (a mapping result of the translation table) and a 6-bit offset 616. The PBA_{tbl} table address 614 is the mapping result of the translation table 420 (FIG. 4) from the index of the LBA_{tbl} 602. The offset 616 is provided by the lower six bits (LSBs) of the LBA from the CBWCB 610. In this case, the 6-bit PBA least significant bit (PBA_{LSB})=6-bit LBA_{LSB} 608.

Referring to FIG. 6B, the values are derived similarly to those in FIG. 6A except that the offset value LBA_{LSB} is 8 bits (due to 512 bytes per sector out of 2K bytes per page of flash memory). The six MSBs of the LBA_{LSB} are concatenated with the PBA_{tbl} to construct the PBA address for the flash memory. The two LSBs of the LBA_{LSB} are used to access 512 bytes out of the 2K-page flash. In this case, 6-bit PBA_{LSB} equals 6-bit MSB from 8-bit LBA_{LSB}.

In accordance with the present invention, flash memory can have different size formats such as a small format and a large format. The small format has a sector size of 512 bytes per page and 16K bytes per erase block. The large format has a sector size of 2K per page and 128K bytes per erase block. The specific sizes will vary and will depend on the specific implementation. The following is an example of a large format flash translation SRAM.

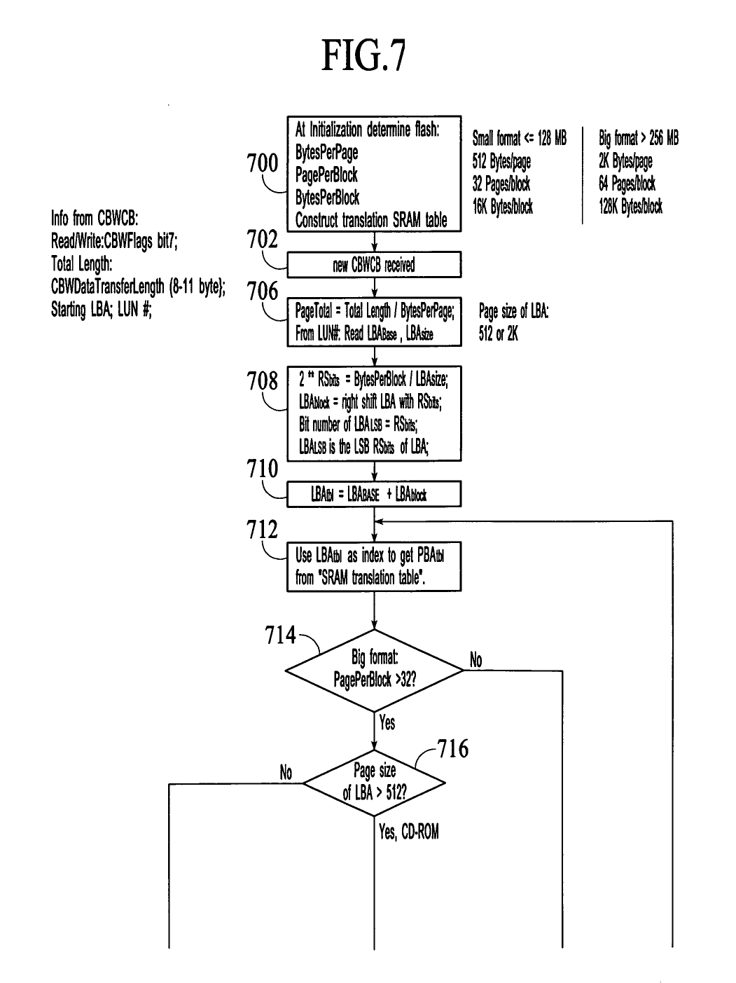

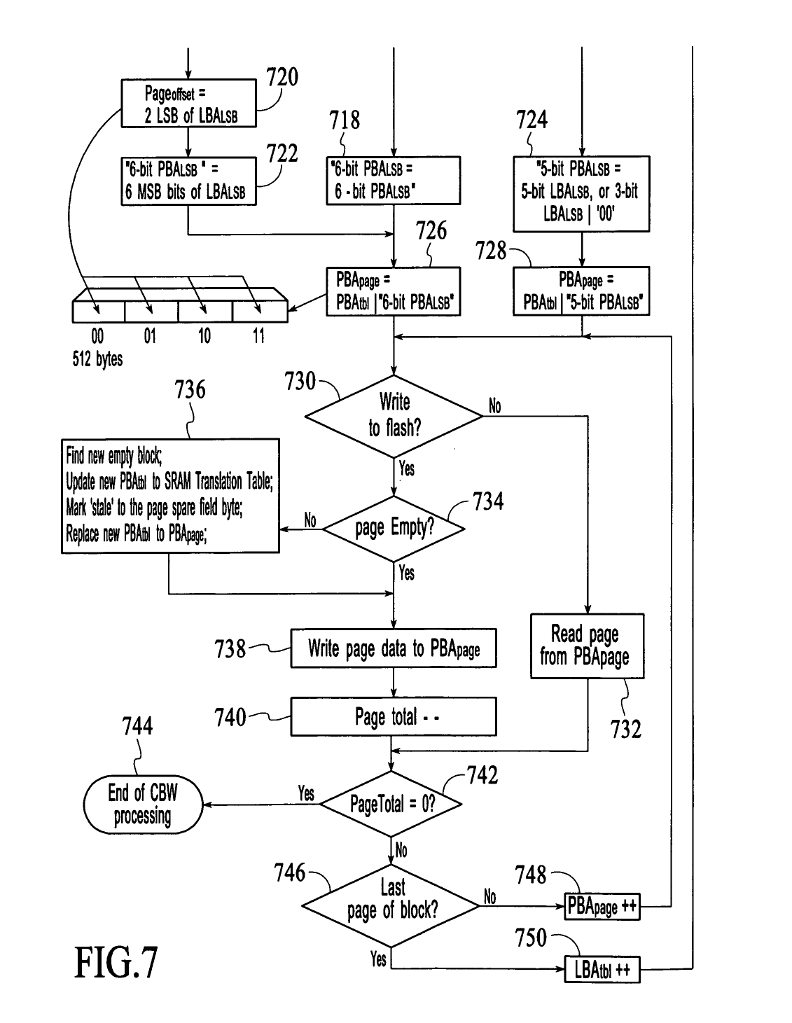

FIG. 7 is a flow chart showing a method for providing the translation table 500 of FIG. 5 in accordance with the present invention. First, the flash memory system is initialized, in a step 700. The flash controller determines the type of flash memory that is in the flash memory system, determines whether the flash memory has a small format or large format, and determines values for the number of bytes per page, pages per block, and bytes per block.

The flash controller also reconstructs the translation table 420 from the flash memory. The device controller reads each first page of each erase block using the physical address from the beginning block to the last. On each read, the device controller reads the block-related information (such as LBA_{tbl}) stored in the spare area next to the data area, which has 2K bytes (or 512 bytes). The device controller then uses the valid LBA_{tbl} as an index to the address translation table 420 and stores a corresponding PBA.

Next, a new CBWCB is received and its information is extracted by the device controller, in a step 702. Such information can include, for example, the total transfer length of bytes requested, whether the command is a read or write command, the LUN number, the starting LBA address, etc.

Next, a base address value LBA_{base} and base address size LBA_{size} is determined based on the LUN number, in a step 706. The total page size (Page Total) is calculated by dividing the total length by the number of bytes per page. Next, an RS_{bits} value is calculated based on the number of bytes per block and the page size of the LBA, in a step 708. The RS_{bits} values are used to calculate values of the LBA_{block} (by right shifting the LBA by RS_{bits}), and are used to calculate the LBA_{LSB} (RS_{bits} bits of the lower LBA).

Next, an index of LBA_{tbl} for the translation table is calculated, in a step 710. Next, the PBA is calculated from the contents of the translation table, in a step 712.

Next, it is determined whether the flash memory is a large or small format, in step 714. If the flash memory is small format (512 bytes per page), the device controller needs a 5-bit PBALSB as the page offset address, in a step 724. The 5-bit PBA_{LSB} will be equal to a 5-bit LBA_{LSB}, or equal to a 3-bit LBA_{LSB} concatenated with two “0”s at the right, depending on the page size of the LBA. In the case where the flash memory is large format (2K bytes per page), it is then determined that the LBA page size is greater than 512 bytes or equal to 512 bytes, in a step 716. If greater than 512 bytes, the 6-bit PBA_{LSB} value will be equal to the 6-bit LBA_{LSB} value, in a step 718. If less than 512 bytes, the page offset value will be equal to the 2 LSBs bits of the LBA_{LSB}, in a step 720, and the 6-bit PBA_{LSB} is equal to 6 most significant bit (MSB) bits of the LBA_{LSB}, in a step 722. The flash controller needs a 6-bit PBA_{LSB} as the page offset address. The 6-bit PBA_{LSB} will be equal to 6-bit LBA_{LSB} or 6 higher bits of 8-bit LBA_{LSB}, depending on the file format sector size of the LBA. Next, the 2 lower bits of an 8-bit LBA_{LSB} is offset, in a step 726.

Next, it is determined if the flash memory access is a read operation or a write operation, in a step 730. If the operation is a read operation, data is read from the PBA page, in a step 732. If it is write operation, it is determined whether the address or the page is already occupied, in a step 734. If occupied, a new empty block is found and updated with the new PBA value to address translation table, in a step 736. As such, a new PBA page is calculated based on the new PBA_{tbl}. If the page is unoccupied, data is written to the PBA page, in a step 738.

Next, the value for the Page Total defined in 706 is decrement by 1, in a step 740. Next, it is determined whether it is the last page of Page Total, in a step 742. If so, the CBWCB process ends, in a step 744. Otherwise, it is determined whether it is the last page of the block, in a step 746. If not, the PBA page is incremented by 1, in a step 748, and the process repeats, beginning at the step 730. If it is determined to be the last page of the block, in the step 746, the LBA_{tbl} is incremented by 1, in a step 750, and the process repeats at the step 712.

Although the index described above has been implemented with a translation table having an absolute addressing scheme, one of ordinary skill in the art will readily realize that the index can be implemented using other schemes and still remain within the spirit and scope of the present invention.

Translation Table—Second Embodiment

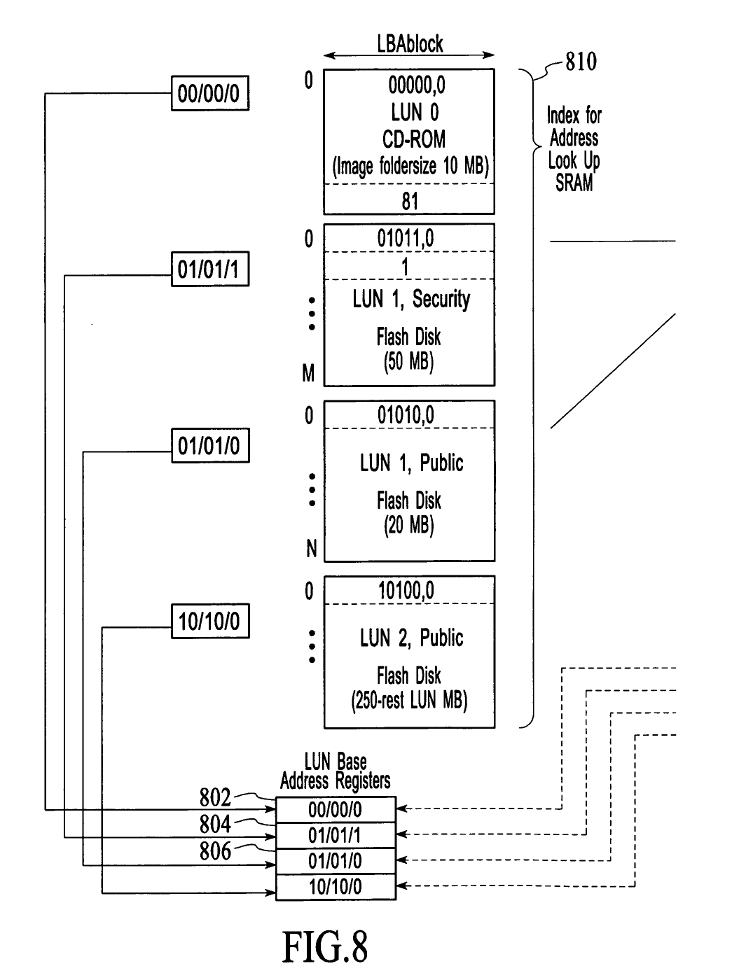

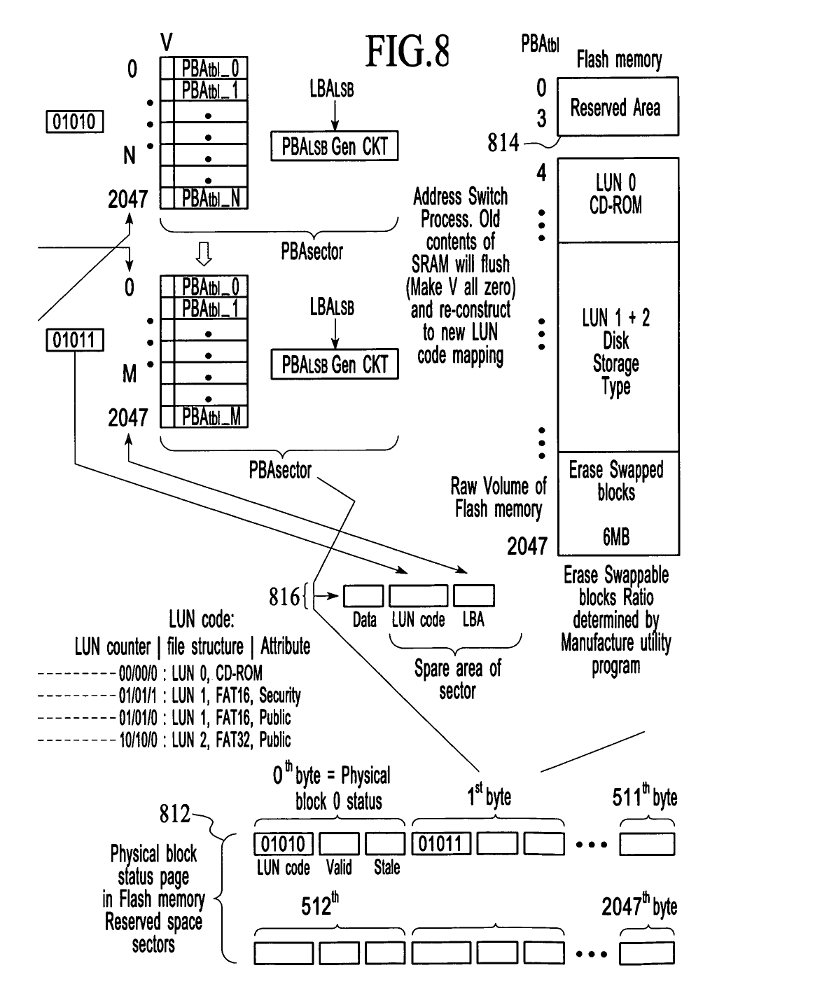

FIG. 8 is a translation table in accordance with another embodiment of the present invention. Each LUN has associated LUN code, which is a LUN counter value cascaded with a file structure, and an attribute. For example, a first LUN base address register 802 stores values for the LUN 0 (associated with a CD ROM partition) has a LUN counter value of 0, a CDFS file structure, a 00 type file system type, a public attribute, results in 00/00/0 code. A second LUN base address register 804 stores values for the LUN 1 (associated with a security partition) has a LUN counter value of 1, a FAT 16 file structure, a 01 type file system type, a security attribute, results in 01/01/1 code. A third LUN base address register 806 stores values for another LUN 1 can also be associated with a public partition. As such, the LUN 1 has a LUN counter value of 1, a FAT 16 file structure, a 01 type file system type, a public attribute, and results in 01/01/0 code.

Generally, the LUN code is used to concatenate with LBAs and to generate corresponding PBAs. For different LUN numbers, the operating system (OS) can generate the same LBA value to access data. A single SRAM look up table can be dedicated for all LUNs. However, when the LUN changes, a reconstruction process is used to rebuild the address translation table in the SRAM device for later OS access. An index 810, which is for the translation table, consists of LUN code concatenated with the LBA. The contents of the translation table provides PBA_{tbl} values. The maximum index number in this example is 2048 (i.e. 256 Mbits flash memory). A copy of every physical block status page 812, which includes LUN code as well as valid states, are stored in flash reserved area 814 for firmware statistics usage. Each page per block 816 of flash physical memory consists of data and spare area. The spare area includes LUN code and LBA information from the host.

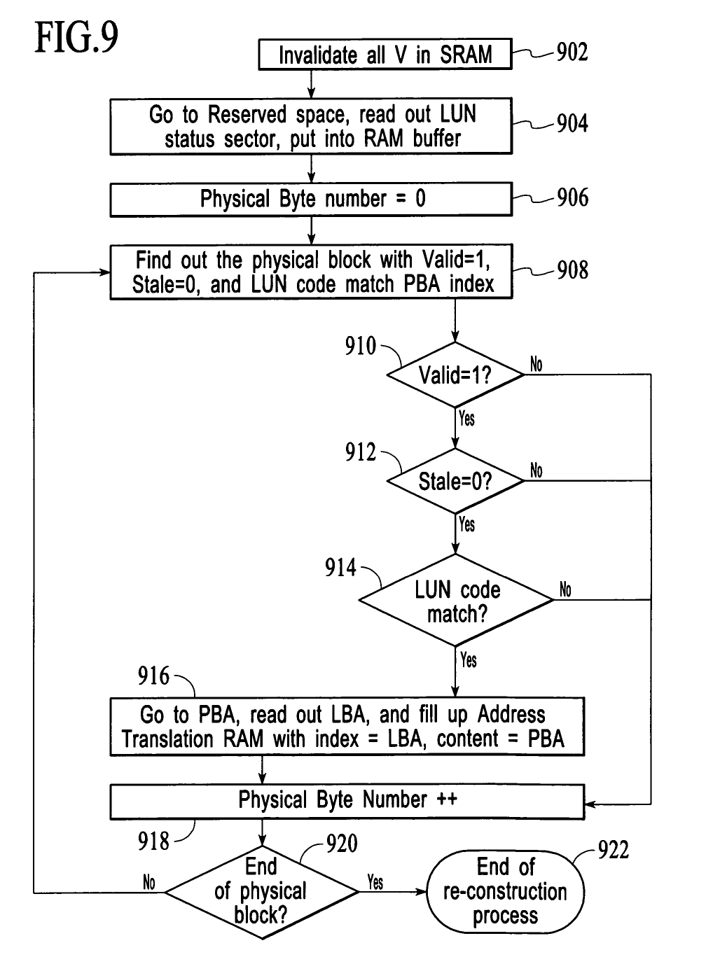

FIG. 9 is a flow chart showing a method for constructing the translation 800 table of FIG. 8 in accordance with the present invention. Generally, referring to both FIGS. 8 and 9 together, if the LUN changes, the contents of the translation table are flushed for each access, and then the translation table is reconstructed.

More specifically, first, in a step 904, the valid flags of all entries are invalidated during a LUN change process. Invalidating the valid flags flushes the translation table. Next, in a step 904, the contents of the physical block status page 812 (FIG. 8) is read from the reserved area 814 in the flash memory. The contents of the physical block status page 812 are then stored in a translation table. The LUN status sector consists of 2 k bytes for 256 MB flash (with 64 pages per block) for example, and each byte represents an associated physical block status (LUN code, valid flag, and stale flag). This is one time that the sector read operation occurs during a LUN change. A 0th byte is linked to a physical block address #0. Only a valid flag set (equals one) and matched LUN code will indicate a valid block status. Stale flag means the block data is out-dated which requires recycling to reclaim the validity.

Next, in a step 906, a physical byte number in the physical block status sector is read sequentially. The physical block status sector has all of the required physical block information (e.g. LUN code, valid flags, stale flags). Next, it is determined whether the physical block fulfills valid download requirements, in a step 908. If yes, it is determined if the valid flag matches, in a step 910, if the stale flag matches a non-stale state, in a step 912, and if the LUN code matches, in a step 914. If yes to all of the steps 910-914, in the flash memory the PBA is used determine the LBA, and then both the PBA and the LBA are used to reconstruct the translation table, in a step 916. Next, the physical byte number is incremented, in a step 918. If either the valid flag, non-stale flag, and the LUN code do not match, the physical byte number is incremented without updating the translation table, in the step 918. The physical block ends, in a step 920, and reconstruction of the new translation table completes, in a step 922. The process returns to the step 908 if the end of the physical block status page 812 has not been reached. This method can support a multiple LUN structure and share a single translation table. Hence, this method can support more OS types and is not limited to the Windows OS.

Manufacturer Utility Programming

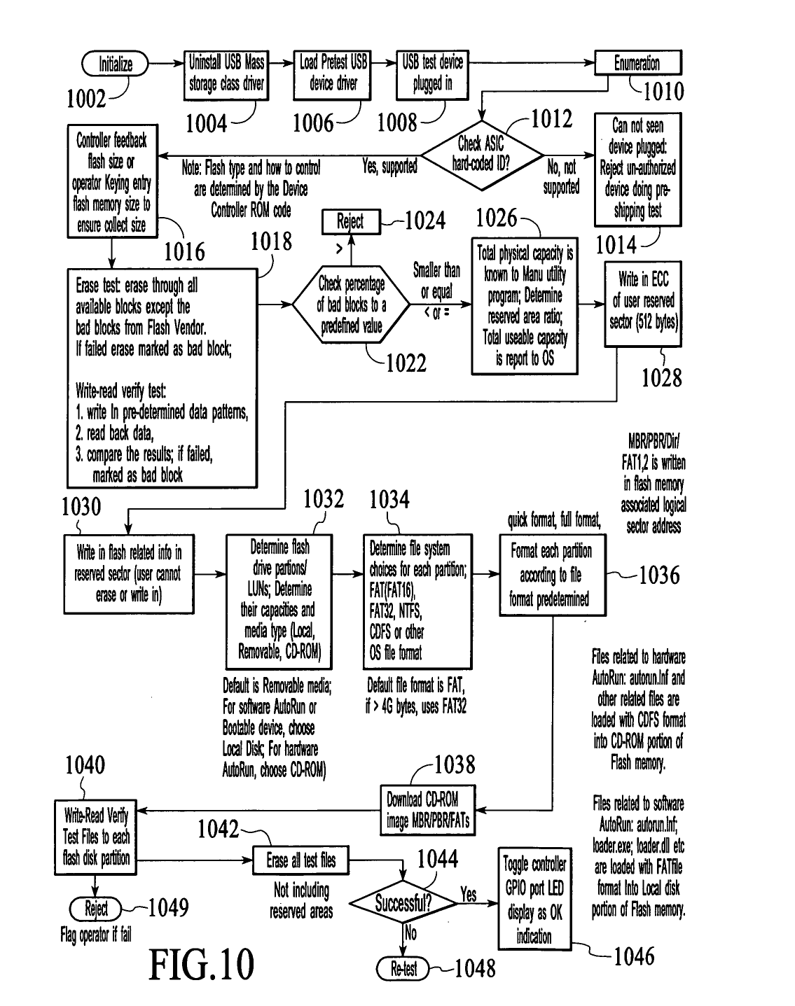

FIG. 10 is a flow chart showing a method for programming a flash memory system 400 of FIG. 4 in accordance with the present invention. The flash memory system 400 is formatted before being shipped to an end-user. A manufacturer utility program which is used to program the flash memory system 400 uses special software drivers. Once the flash memory system 400 is programmed, the end user cannot change basic structure even by formatting the flash memory system 400 using an operating system such as Windows OS.

First the manufacturer host is initialized, in a step 1002. Next, a USB mass storage class driver is uninstalled, in a step 1004. Next, a pretest USB driver is loaded, in a step 1006. The pretest USB driver support special manufacturing commands. Next, the flash memory system is connected to the manufacturer host, in a step 1008. Next, an enumeration process is executed, in a step 1010. Next, a partial variable enumeration descriptor field value, which is custom made for each flash memory, is loaded. For example, the serial number of each flash memory has to be unique for each mass storage class driver needed. Also, the product ID and version number is provided each time the firmware code is updated.

Next, an ASIC hard-coded ID in the flash memory system is checked, in a step 1012. If the ASIC hard-coded ID does not match, the flash memory system is rejected by utility software, in a step 1014. If the ASIC hard-coded ID matches, the ROM firmware in the flash memory system identifies the flash memory type and capacity, and then sends this information to the manufacturer host, in a step 1016. Alternatively, this information can be entered into the manufacturer host manually.

Next the data in the flash memory is erased and pre-assigned patterns are written to the flash memory, in a step 1018. In a specific embodiment, only blocks with good flags are erased. Blocks that fail to erase or that cannot be written to correctly are marked as bad blocks and these blocks are recorded in a bad block table in the reserved area of the flash memory.

Next, the percentage of bad blocks are checked, in a step 1020. This percentage is compared to a predetermined value that is either pre-programmed or manually keyed-in, in a step 1022. If the percentage is greater than the predetermined value, the flash memory system is rejected, in a step 1024. Next, if the percentage is less than or equal to the predetermined value, the total physical capacity of the flash memory and a reserved ratio is determined, in a step 1026. Next, error correction code (ECC) (e.g. checksum of reserved sector codes) is written in dedicated physical address of the flash memory using special manufacturing commands, in a step 1028. Firmware in the flash controller checks the ECC each time reserved sector codes are updated to another empty reserve space, and an outdated copy is erased.

Next, flash related information is written into the reserved area, in a step 1030. Run-time code is part of the booting processes. Any codes that are not directly involved with the initial booting of the controller are put into the flash memory device to reduce the ROM size of the device controller. Enumeration field programmed values (e.g. serial number and product version number) as well as some partition (volume) sizes are loaded in at the same time. Some special loading commands can be recognized by the flash controller and load values in the flash reserved areas which the user cannot modify or erase. A device embedded controller ASIC ID and the write-in special password code is checked when the reserved area is accessed. Run-time code is loaded to the reserved area. The code can be updated if any bugs are found or if newer versions are available. Also, a notice to a manufacturer operator may be indicated using an LED as to whether a tested device tests okay or not.

Next, flash drive partitions, capacities, media types, and LUNs are determined, in a step 1032. Specifically, the number of partitions is determined along with the capacity, media type, and associated LUNs for each partition. Each LUN can be or have different capacities, media types, and LUN numbers. Once the partition number is determined by the manufacture utility program, a user can not change back or alter the numbers.

Next, file system formats for each partition are determined, in a step 1034. Such file system formats include CDFS, FAT16, FAT 32, NTFS, etc. Next, each partition is formatted according to the file system determined in the step 1036. For each partition, a partition table, partition type, and total capacity are loaded by the manufacturer host OS, in a step 1036. Such information is required for the files in the partitions to be recognized. The device is formatted according to a desired file structure determined by the manufacturer operator. For example, FAT16/32/NTFS is very common to PC users. Each choice may depend on device volume supported, and if the size is larger than 1 G byte, FAT32 will be best choice for this device as FAT16 no longer fits. The partition block record (PBR), 2 copies of the FAT, and the root directory are preloaded for the end users, in a step 1038.

Next, a final write-read test is performed, in a step 1040. During this test, the allowable storage portions of the partitions are written to and read to ensure that they function properly. Any corrupted file structures are also tested to guarantee user storage safety. Any failures get flagged, in a step 1040.

Next, the allowable storage portions of the partitions are erased to an empty state, in a step 1042. Next it is determined if the entire process was successful, in a step 1044. If successful, an LED display indicates so with a particular flashing pattern, in a step 1046. The LED display is connected to a general purpose I/O port. Any untested flash memory system will show a different flashing pattern (or no pattern) when plugged in the manufacturer host, in a step 1048. This indicates whether a flash memory system has been programmed and tested.

AutoRun Function

Configuring a CD ROM partition to the flash memory device enables it to support the AutoRun function. AutoRun is an operating system feature that enables associated files to automatically open a document or execute an application when a CD is inserted in a CD ROM drive of a computer. For example, when a user inserts a CD into a CD ROM drive, the AutoRun function enables the CD to automatically start an installation program or a menu screen. The AutoRun function is typically seen during a software installation when a Windows OS disk or CD ROM is inserted into a computer system.

In accordance with the present invention, the AutoRun function is implemented by a combination of configuring a partition in the CD ROM format and modifying by creating an extra partition of the flash memory system firmware and hardware.

Enumeration

The Windows OS can support the AutoRun function using a partition that is either a CD ROM-type partition, or a fixed-disk partition (typically used for hard disk drives or ZIP drives). In one embodiment of the present invention, the AutoRun function is implemented using a partition that is a CD ROM-type partition, as describe above. As such, the enumeration is modified so that it informs the OS that the flash memory device is not a removable device but is instead a CD-ROM device. Also, the ROM code in the flash controller is modified so that the ROM code supports the AutoRun function.

In an alternative embodiment of the present invention, the AutoRun function can be implemented using a partition that is a fixed-disk partition. As such, the partition associated with the AutoRun function is formatted as a fixed disk. This may be referred to as a software implementation, since the software for the AutoRun function can run without having to make any hardware changes to the flash memory system. However, files related to the AutoRun feature can be deleted if the AutoRun file are stored in a fixed-disk partition, but it cannot be deleted if the AutoRun file are stored in a CD-ROM partition.

Advertising Feature

As described above, the AutoRun function is utilized to automatically execute a software program. In a specific embodiment, the software program can provide advertising. For example, when the flash memory system is plugged into a user host, the AutoRun function can automatically execute a software program that delivers an advertisement via the host. The advertisement can be visual using a monitor attached to the user host. The advertisement can also be auditory using speakers attached to the user host. The specific mode of advertisement will vary and will depend on the specific application. The advertising feature can also be configured such that the end user cannot erase advertising materials themselves.

Testing Software Feature

Computer diagnostic software can be implemented by the AutoRun feature. A benefit of this is that the software image can be protected not allowing the software image to be reverse engineered. Also, the AutoRun function is user friendly because test functions of the computer diagnostic software can be automatically executed. A floppy disk can serve a similar function but without the image protection.

Keying Feature

Keying software can be implemented using the AutoRun feature, where the keying software program provides privileges for accessing the host system. For example, if the flash memory device is plugged into the USB port, the AutoRun feature automatically executes a keying software in the host system. If the user unplugs the flash memory device from the USB port, the host system will be locked.

User Profile Feature

User profile software can be implemented using the AutoRun feature, where the user profile software provides user profile information associated with each application. For example, the user profile information can include user-customized settings for internet browser options (e.g. bookmarks, default home page), email settings, Word settings, etc.

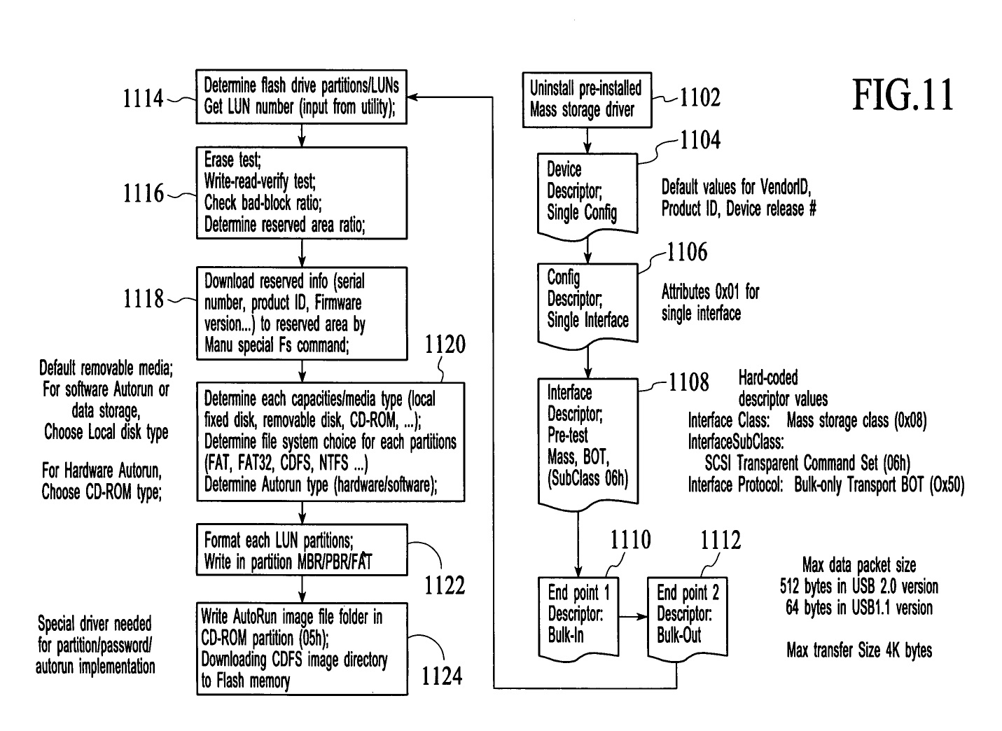

FIG. 11 is a flow chart showing a method for setting-up an AutoRun function with a manufacture host in accordance with the present invention. Before the manufacturer utility program starts, the old mass storage driver is uninstalled, in a step 1102. Next, a device descriptor is set to a single configuration, in a step 1104. Next, a configuration descriptor is set to a single interface, in a step 1106. Next, interface descriptors are set, in a step 1108. These descriptors include an interface class (e.g. mass storage class), interface subclass (e.g. SCSI transparent command set), and interface protocol (e.g. bulk-only transport BOT). Next, a first endpoint descriptor (i.e. bulk-in) is set, in a step 1110. Next, a second endpoint descriptor (i.e. bulk-out) is set, in a step 1112. These two endpoints are needed to implement bulk-in and bulk-out operations. Next, the partitions and LUNs are determined, in a step 1114. After enumeration is completed, a mass storage class request (e.g. get-max-LUN command) is issued to the flash memory system, and a default number of LUNs is returned. Alternatively, an operator manually enters information using a manual test utility program.

Next, an erase test and a write-read test are executed, and bad-block and reserved area ratios are determined, in a step 1116. Next, reserved information is downloaded into the flash memory, in a step 1118. Reserved information includes a serial number, a vendor, a product ID, a firmware version, etc. This information is available for access by an OS driver during enumeration process in normal operation mode. Information such as mass storage class, BOT, and SCSI subclass are returned to the manufacturer host. Next, the partition capacities, media types, file system types, and AutoRun types are determined, in a step 1120. A utility program issues special command (i.e. F0h) to increment counters after each LUN partition recording file structure information in the flash memory. The partition information is saved in the flash memory reserved space for future user reference. File structure information such as master block record (MBR), partition block record (PBR), FATs per partition must be pre-programmed and saved in an OS accessible area.

To enable the CD ROM AutoRun function, all executive files must be stored in a CDFS format. The access method for a CD ROM file is different from that for a disk storage file. Next, each LUN partitions are formatted, in a step 1122. Next, a CDFS image directory is downloaded to the flash memory together with AutoRun image files to the CD ROM partition, in a step 1124.

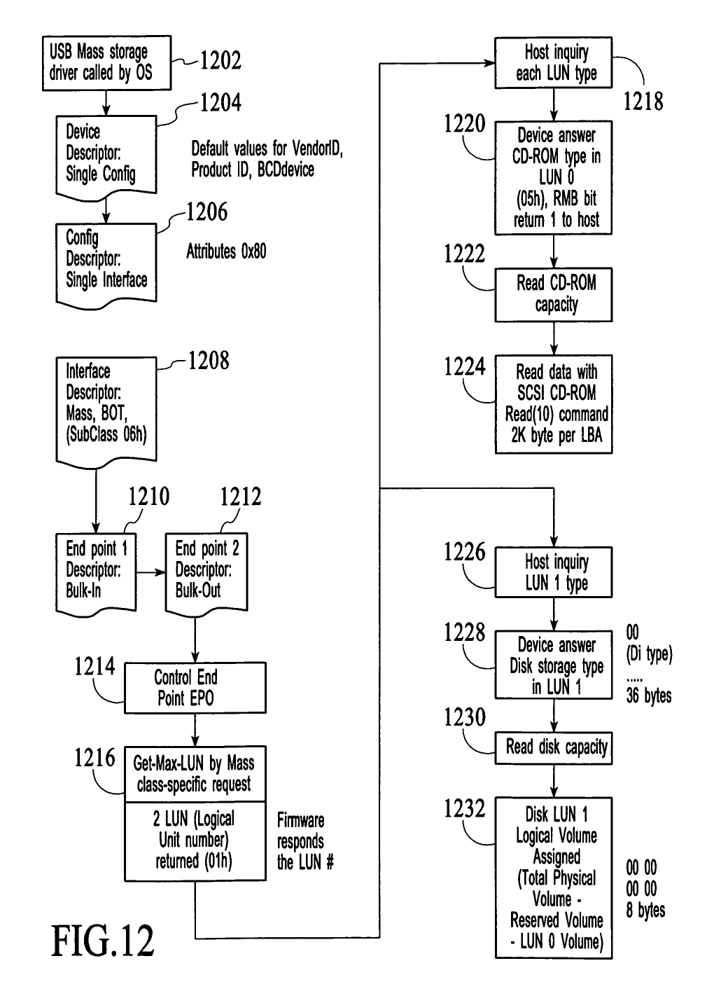

FIG. 12 is a flow chart showing a method for running an AutoRun function during user mode in accordance with the present invention. When a user plugs the flash memory system into a user host, the USB mass storage driver is executed by the OS, in a step 1202. Next, a device descriptor is set to a single configuration, in a step 1204. Next, a configuration descriptor is set to a single interface, in a step 1206. Next, interface descriptors are set, in a step 1208. These descriptors include an interface class (e.g. mass storage class), an interface subclass (e.g. SCSI transparent command set), and an interface protocol (e.g. bulk-only transport). Next, a first endpoint descriptor (i.e. bulk-in) is set, in a step 1210. Next, a second endpoint descriptor (i.e. bulk-out) is set, in a step 1212. Next, a control endpoint (EP0) is set, in a step 1214. Next, the maximum LUN is retrieved, in a step 1216, and 2 LUNs is assumed in this example.

The following steps involve a CD ROM partition. After the step 1216, if a CD ROM partition is involved, the user host requests the LUN type for the CD ROM partition, in a step 1218. Next, the LUN types are sent to the user host, in a step 1220. Next, once the LUN for the CD ROM partition is confirmed, the CD ROM capacity is read, in a step 1222. Next, data is read with a SCSI CD ROM read command, in a step 1224.

The following steps involve disk partitions other than a CD ROM partition. After the step 1216, if a disk partition other than a CD ROM partition is involved, the user host requests the LUN type for disk partitions, in a step 1226. Next, the LUN types are sent to the user host, in a step 1228. Next, once the LUN type for the disk partition is confirmed, the disk partition storage capacity is read, in a step 1230. Next, a volume is assigned by user host operating system, in a step 1232.

Enumeration reads out string values stored in flash memory reserved space. Since the AutoRun function is enabled by the CD ROM partition, the pre-stored image will be executed automatically. At the same time the AutoRun feature is executed, the normal disk type storage function is enabled for the user.

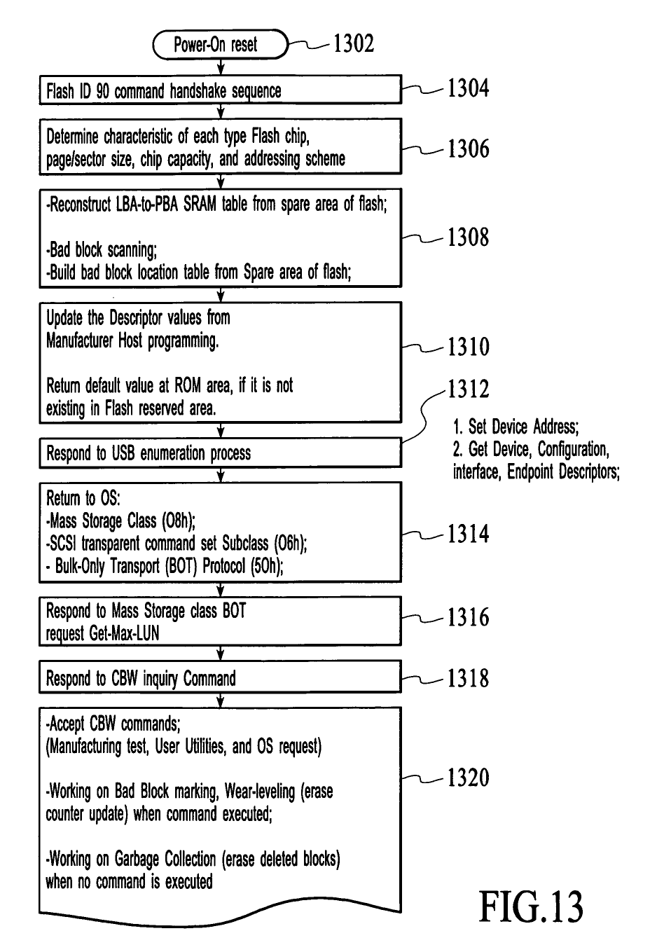

FIG. 13 is a flow chart showing a method for booting up a ROM of the flash memory device in accordance with the present invention. First, a power-on reset operation is initiated, in a step 1302. Next, a flash ID handshake sequence (i.e. Flash memory chip address 90h read command) is executed, in a step 1304. Next, characteristics of each flash memory chip are determined, in a step 1306. Such information includes page/sector size, chip capacity, addressing schemes, etc. A flash device running code image file is fetched from the reserved area.

Next, an LBA-to-PBA table is reconstructed using information in the reserved area, in a step 1308. Next, descriptor values are updated, in a step 1310. Next, an enumeration process is executed by the host, in a step 1312. During the enumeration process, the user host requests information such as device type and its configuration characteristics. Next, pre-programmed values stored in the reserved area are returned to the user host, in a step 1314. If a flash memory chip is empty, default hard-coded values are provided. The user host assigns new addresses to the flash memory each time during the enumeration process. The firmware records new address values for on-going transactions.

Next, the firmware responds to mass storage class BOT requests, in a step 1316. For example, a request can be for the maximum LUN supported by the device. As such, the correct numbers stored in the reserved area are returned to the user host. If the flash memory is empty, a default value (e.g. 00h, or at least one LUN) is returned.

Next, CBW inquiry commands are responded to, in a step 1318. Since the number of partitions is known in advance, an LUN counter increments after each partition returns its characteristic value. The original CBW is replaced with a current LUN value for storing MBR/PBR system file structures to the flash memory. For various CBW commands, firmware provides subroutines to execute different commands including commands for recycling of old used blocks. Next, CBW commands are accepted, in a step 1320.

Security Partition

In a specific embodiment, a secured partition and a public partition share the same logic unit number. In accordance with the present invention, a security utility program allows a secured partition and a public partition to share the same LUN number of the flash memory. Accordingly, the OS can process data from these areas without distinguishing between the partitions. In a specific embodiment, the capacity volume of each partition can be varied with a fixed total size. This can be done using a utility program. This is beneficial because it provides flexibility for data storage.

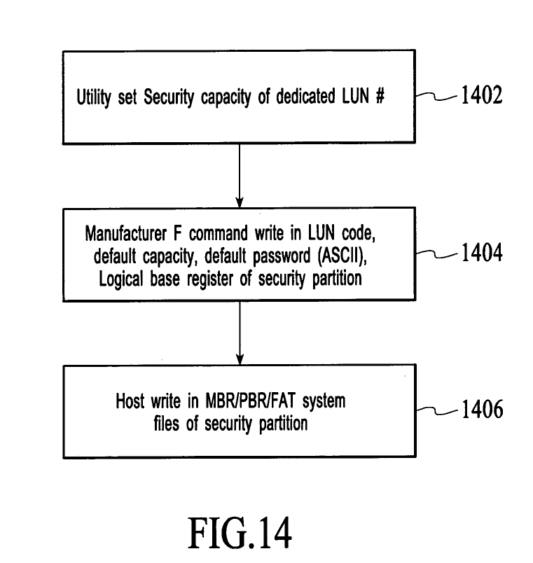

FIG. 14 is a flow chart showing a method for setting up a security partition of the manufacturing test in accordance with the present invention. First, an initial capacity is set for a dedicated secured partition, in a step 1402. Next, a LUN code, a default capacity, a default password, and logical base address registers are written, in a step 1404. Next, MBR/PBR/FAT system files of the security partition are written, in a step 1406.

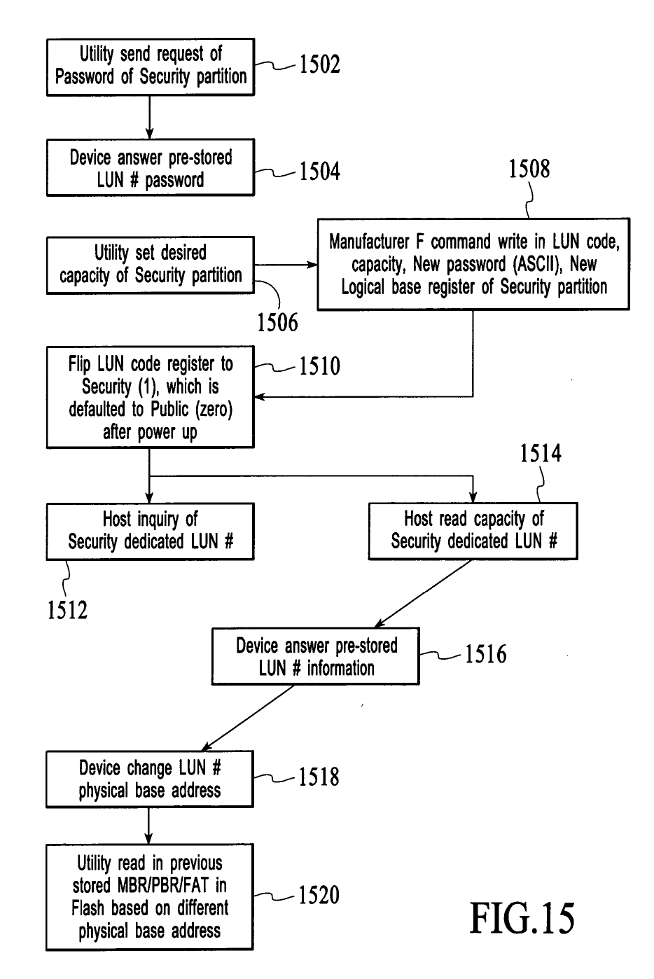

FIG. 15 is a flow chart showing a method for operating a security partition in user mode in accordance with the present invention. First, a password for the security partition is requested, in a step 1502. Next, a pre-stored LUN password is provided for matching purposes, in a step 1504. Next, a capacity for the security partition is set, in a step 1506. Next, a LUN code, a capacity, a new update password, and logical base registers are written, in a step 1508. Next, a LUN code register is set to a secured mode, in a step 1510. The default is public mode after power up. Next, the LUN for the secured partition is requested by the user host in the case where the security partition and the public partition are not sharing the same LUN, in a step 1512. Next, the capacity of the secured partition is read by the user host, in a step 1514. Next, pre-stored LUN information is provided, in a step 1516. Next, a physical base address for the secured partition is provided, in a step 1518. Next, previously stored MBR/PBR/FAT information in the flash is read, in a step 1520. Password security partition can share with public data partition with same LUN. After powering up the flash memory system, a default public area will appear. A security utility program is requested and the correct password is given to enable the security function.

A security partition can exist in a storage area of the flash memory. A default capacity is loaded by a manufacturer utility, and a special driver is used by the manufacturing host for power-up formatting so that the user can perform his or her own initial formatting after receiving the flash memory device. If a correct password is provided upon a utility software inquiry request, an attribute register is set so that the user can choose a security partition over a public partition.

New MBR, PBR, FAT values are stored in the flash memory by the user host. Then, the user can save and access secured data that is password protected. After a user logs off, the previous public partition will be displayed because the attribute register resets by default. As such, the public partition LUN code will restore the LBA base register, and pre-stored system files will be read in order to maintain data consistency. Whenever the capacity or file structure changes, formatting is typically performed. As such, old data is erased and new system files are loaded.

According to the system and method disclosed herein, the present invention provides numerous benefits. For example, it provides a more flexible flash memory system by increasing its functionality. Also, the present invention can be applied to any controller-embedded Flash card including but not limited to MultiMediaCard (MMC), Secure Disk (SD), Memory Stick (MS), and Compact Flash (CF). A system for implementing a flash memory system has been disclosed. The flash memory system includes flash memory having multiple partitions. The flash memory system can utilize the multiple partitions to provide multiple functions. The functions can include, for example, an AutoRun function, non-secured data storage, and secured data storage.

The present invention has been described in accordance with the embodiments shown. One of ordinary skill in the art will readily recognize that there could be variations to the embodiments, and that any variations would be within the spirit and scope of the present invention. For example, the present invention can be implemented using hardware, software, a computer readable medium containing program instructions, or a combination thereof. Software written according to the present invention is to be either stored in some form of computer-readable medium such as memory or CD ROM, or is to be transmitted over a network, and is to be executed by a processor. Consequently, a computer-readable medium is intended to include a computer readable signal, which may be, for example, transmitted over a network. Accordingly, many modifications may be made by one of ordinary skill in the art without departing from the spirit and scope of the appended claims.

What is claimed is:

1. A flash memory system comprising:
a processor; and
at least one flash memory device coupled to the processor, wherein the at least one flash memory device includes a plurality of partitions.

2. The system of claim 1 further comprising an index coupled to the processor, wherein the index comprises information regarding a configuration of the at least one flash memory device, wherein the index provides access to the plurality of partitions.

3. The system of claim 2 wherein the index associates logic unit numbers (LUNs) with each of the partitions.

4. The system of claim 3 wherein one LUN can correspond to one or more of the partitions.

5. The system of claim 3 wherein the index maps the LUNs to logical block addresses (LBAs) and physical address blocks (PBAs).

6. The system of claim 1 wherein each partition of the plurality of partitions can have a different file structure.

7. The system of claim 1 wherein the at least one flash memory device comprises sectors having sizes of at least 512 bytes.

8. The system of claim 1 wherein at least one partition of the plurality of partitions is formatted as a compact disk (CD) read-only memory (ROM) partition.

9. The system of claim 8 wherein the at least one partition being formatted as a CD ROM partition enables the flash memory system to support an AutoRun function.

10. The system of claim 9 wherein the AutoRun function is utilized to automatically execute a software program.

11. The system of claim 10 wherein the software program provides advertising.

12. The system of claim 10 wherein the software program provides a host system testing function.

13. The system of claim 10 wherein the software program provides privileges for accessing the host system.

14. The system of claim 10 wherein the software program provides user profile information.

15. The system of claim 1 wherein at least one partition of the plurality of partitions is formatted as a disk partition.

16. The system of claim 15 wherein the at least one partition is configured as a public partition.

17. The system of claim 16 wherein at least one second partition of the plurality of partitions is formatted as a disk partition, wherein the at least one second partition is configured as a secured partition.

18. The system of claim 15 wherein a password is required to access the secured partition.

19. The system of claim 17 wherein the secured partition and the public partition can share a same LUN.

20. The system of claim 1 wherein the flash memory system is universal serial bus (USB) compatible.

21. The system of claim 1 wherein the flash memory device comprises a reserved area for storing control information for the flash memory device.

22. The system of claim 21 wherein a plurality of copies of the control information are made and stored in the reserved area.

23. A system for implementing a flash memory card, the system comprising:
a user host;
a flash memory card coupled to the user host, the flash memory card comprising:
a processor; and
at least one flash memory device coupled to the processor, wherein the at least one flash memory device includes a plurality of partitions.

24. The system of claim 23 further comprising an index coupled to the processor, wherein the index comprises information regarding a configuration of the at least one flash memory device, wherein the index provides access to the plurality of partitions.

25. The system of claim 24 wherein the index associates logic unit numbers (LUNs) with each of the partitions.

26. The system of claim 25 wherein one LUN can correspond to one or more of the partitions.

27. The system of claim 25 wherein the index maps the LUNs to logical block addresses (LBAs) and physical address blocks (PBAs).

28. The system of claim 23 wherein each partition of the plurality of partitions can have a different file structure.

29. The system of claim 23 wherein the at least one flash memory device comprises sectors having sizes of at least 512 bytes.

30. The system of claim 23 wherein at least one partition of the plurality of partitions is formatted as a compact disk (CD) read-only memory (ROM) partition.

31. The system of claim 30 wherein the at least one partition being formatted as a CD ROM partition enables the flash memory system to support an AutoRun function.

32. The system of claim 31 wherein the AutoRun function is utilized to automatically execute a software program.

33. The system of claim 32 wherein the software program provides advertising.

34. The system of claim 32 wherein the software program provides host system testing function.

35. The system of claim 32 wherein the software program provides privileges for accessing the host system.

36. The system of claim 32 wherein the software program provides user profile information.

37. The system of claim 23 wherein at least one partition of the plurality of partitions is formatted as a disk partition.

38. The system of claim 37 wherein the at least one partition is a public partition.

39. The system of claim 38 wherein at least one second partition of the plurality of partitions is formatted as a disk partition, and wherein the at least one second partition is configured as a secured partition.

40. The system of claim 38 wherein a password is required to access the secured partition.

41. The system of claim 39 wherein the secured partition and the public partition can share a same LUN.

42. The system of claim 23 wherein the flash memory system is universal serial bus (USB) compatible.

43. The system of claim 23 wherein a manufacturing utility program is used for initially programming the flash memory card to enable the flash memory card to be used during normal mode operation.

44. A method for implementing a flash memory system, the method comprising:
providing at least one flash memory device; and
creating a plurality of partitions in the at least one flash memory device.

45. The method of claim 44 further comprising:
providing a processor; and
providing an index, wherein the index comprises information regarding a configuration of the at least one flash memory device, and wherein the processor can utilize the index to create the plurality of partitions in the at least one flash memory device.

46. The method of claim 45 wherein the index providing step comprises mapping an LUN and logical block address (LBA) to a physical address block (PBA).

47. The method of claim 46 wherein the LUN and LBA are used by device firmware to calculate the PBA.

48. The method of claim 46 wherein the LUN and LBA to PBA mapping step comprises associating the LUN with a LUN code, wherein the LUN code comprises a LUN counter value cascaded with a file structure and an attribute, and wherein the LUN code is used to determine the PBA.

49. The method of claim 44 wherein the plurality of partitions providing step comprises:
determining the number of partitions;
determining the capacity of each partition; and
determining the media type of each partition.

50. The method of claim 44 wherein the plurality of partitions providing step comprises:
determining a file system format for each partition; and
formatting each partition according to the determined file system format.

51. The method of claim 50 wherein the formatting step comprises formatting at least one partition as a compact disk (CD) read-only memory (ROM) partition.

52. The method of claim 51 wherein the at least one partition being formatted as a CD ROM partition enables the flash memory system to support an AutoRun function.

53. The method of claim 44 further comprising executing an AutoRun function.

54. The method of claim 53 further comprising utilizing the AutoRun function to automatically execute a software program.

55. The method of claim 54 further comprising providing advertising with the software program.

56. The method of claim 54 further comprising providing a host system testing function.

57. The method of claim 54 further comprising providing privileges for accessing the host system.

58. The method of claim 54 further comprising providing user profile information.

59. The method of claim 50 wherein the formatting step comprises formatting at least one partition as a disk partition.

60. The method of claim 59 wherein the at least one partition is a public partition.

61. The method of claim 60 further comprising formatting at least one second partition as a disk partition, wherein the at least one second partition is configured as a secured partition.

62. The system of claim 60 wherein a password is required to access the secured partition.

63. The method of claim 61 wherein the secured partition and the public partition can share a same logic unit number (LUN).

64. The method of claim 44 further comprising:
providing a reserved area; and
storing control information in the reserved area.

65. The method of claim 64 further comprising:
providing a plurality of copies of the control information; and
storing the plurality of copies of the control information in the reserved area.

66. A computer readable medium containing program instructions for implementing a flash memory system, the program instructions which when executed by a computer system cause the computer system to execute a method comprising:
providing at least one flash memory device; and
creating a plurality of partitions in the at least one flash memory device.

67. The computer readable medium of claim 66 further comprising program instructions for:
providing a processor; and
providing an index, wherein the index comprises information regarding a configuration of the at least one flash memory device, and wherein the processor can utilize the index to create the plurality of partitions in the at least one flash memory device.
